(19) United States
(12) Patent Application Publication
(10) Pub. No.: US 2015/0253825 A1
(43) Pub. Date: Sep. 10, 2015

(54) POWER SUPPLY FOR A TWO-WIRE MODULE

(71) Applicant: Honeywell International Inc., Morristown, NJ (US)

(72) Inventors: Josef Hladky, Brno (CZ); Ondrej Ficner, Albrechtice (CZ); Ivo Chromy, Rajhrad (CZ); Cory Grabinger, Maple Grove, MN (US)

(73) Assignee: Honeywell International Inc., Morristown, NJ (US)

(21) Appl. No.: 14/196,709

(22) Filed: Mar. 4, 2014

(51) Int. Cl. G06F 1/26; G06F 13/40

(52) U.S. Cl. CPC G06F 1/26; G06F 13/4068

(57) ABSTRACT

A power supply approach and mechanism for electrical devices using a polarity-insensitive two-wire bus that can carry data and power. However, some devices, such as CO2 sensors and secure digital memory cards, may need certain amounts of energy for measuring and writing data, respectively, that are more intense than the amount of energy available on the two-wire bus. Sensor, card and other device data may be conveyed by the two-wire bus. The present approach and mechanism may convert power from the two-wire bus into intense energy that can enable the sensors, cards and other devices to satisfactorily operate. A current limiter may be incorporated to protect the two-wire bus from loss of data and energy for slave devices on the bus during a period of charging a storage cell in that an empty huge storage capacitor connected to bus directly could short the bus.

### BACKGROUND

The present disclosure pertains to power supplies and particularly to power supplies designed for providing certain kinds of outputs.

### SUMMARY

The disclosure reveals a power supply approach and mechanism for electrical devices using a polarity-insensitive two-wire bus that can carry data and power. However, some devices, such as CO2 sensors and secure data or digital memory cards, may need amounts of energy for measuring and/or writing data, respectively, that are more intense than the amount available on the two-wire bus. Data for the sensors may be conveyed by the two-wire bus. The present approach and mechanism may convert power from the two-wire bus into a form of energy that can enable the sensors and cards to satisfactorily to measure and/or write data. A current limiter may be incorporated to protect the two-wire-bus from loss of data and energy for slave devices on the bus during a period of charging of the storage cell in that an empty huge capacitor connected to bus directly could totally short the bus. The present approach and mechanism may be applicable to other electrical devices that utilize the two-wire bus for conveying data but need more intense energy than is available on the bus to operate adequately.

### BRIEF DESCRIPTION OF THE DRAWING

FIG. 1 is a diagram of a module having a two-wire connection and a sub-module for providing extra power to the module when needed;

FIG. 2 is a diagram showing circuit details of the module in FIG. 1; and

FIG. 3 is a functional block diagram of a DC to DC converter.

### DESCRIPTION

The present approach and mechanism may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

The present approach may solve an issue of many wires needed for having features like CO2, humidity, temperature measurement, LCD and buttons user interface and secure digital card writing available on a two-wire sylk sensor system.

Wiring for a multi-point transfer today may require up to eight wires running and terminating at one or more sensors. Sylk™ (sylk) bus technology may be available from Honeywell International Inc. and may allow virtually all of the point information to be sent on just two polarity insensitive wires thereby saving installation time, wiring errors and materials. But a drawback may be the limited amount of instantaneous energy available from the sylk bus to the sensor. To date, applications like CO2 measurement and secure digital (SD) card writing have not necessarily been possible to offer on the sylk bus, because of a lack of quick presence of energy when needed.

A two-wire bus approach may be described in U.S. Pat. No. 7,966,438, issued on Jun. 21, 2011, and entitled “Two-Wire Communications Bus System”. U.S. Pat. No. 7,966,438, issued on Jun. 21, 2011, is hereby incorporated by reference.

Marketing may have labeled the two-wire approach as “game changing”. The approach is possible by incorporating a new current limited power supply circuit to charge a local capacitor/storage cell. An onboard microcontroller may monitor the voltage in the storage cell and calculate when there is sufficient energy in the cell to conduct an energy intensive action like a CO2 measurement or writing of a flash memory.

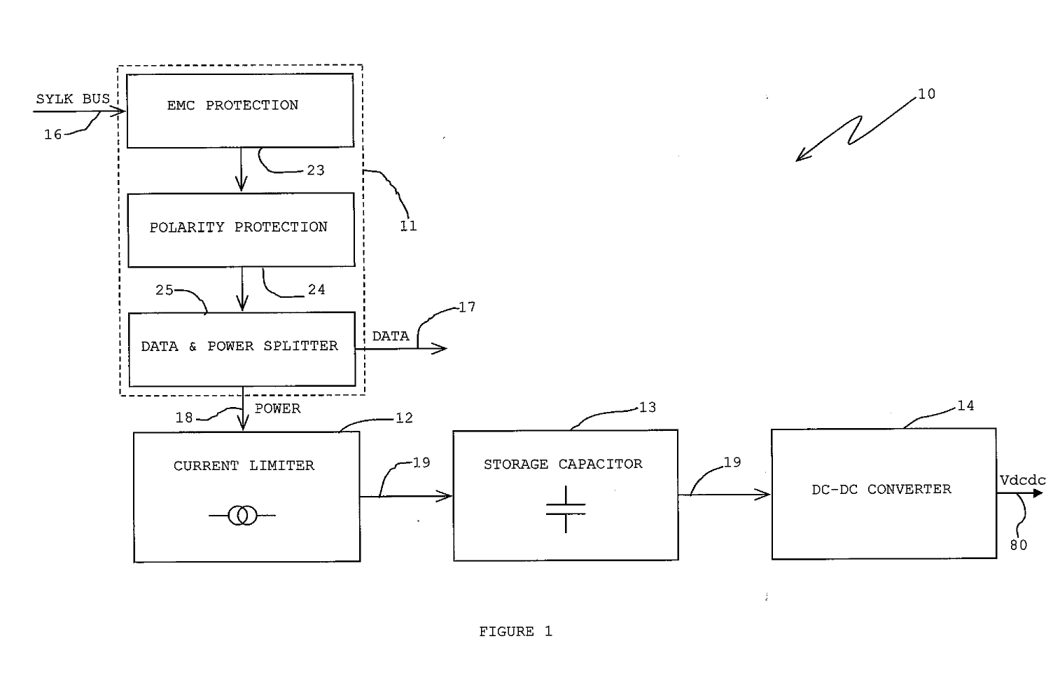

FIG. 1 is a diagram of an example two-wire mechanism, module, approach or device 10 that may have a sub-module 11. The module or device may be for a CO2 or some other sensor or electronic function requiring energy intensive action. Sub-module or circuit 11 may incorporate an electromagnetic compatibility (EMC) protection circuit 23, a polarity protection (e.g., a rectifier) circuit 24 and a data and power splitter 25. An output 18 from sub-module 11 may go to a current limiter 12. An output 19 may go from current limiter 12 to a storage capacitor circuit 13. An output 19 may go from capacitor 13 to a DC-DC converter 14. Power sub-module 11 may have a connection with a sylk bus 16 to provide power and a data. Data may be taken from a splitter circuit 25. A power connection may be made from power sub-module 11 to current limiter 12.

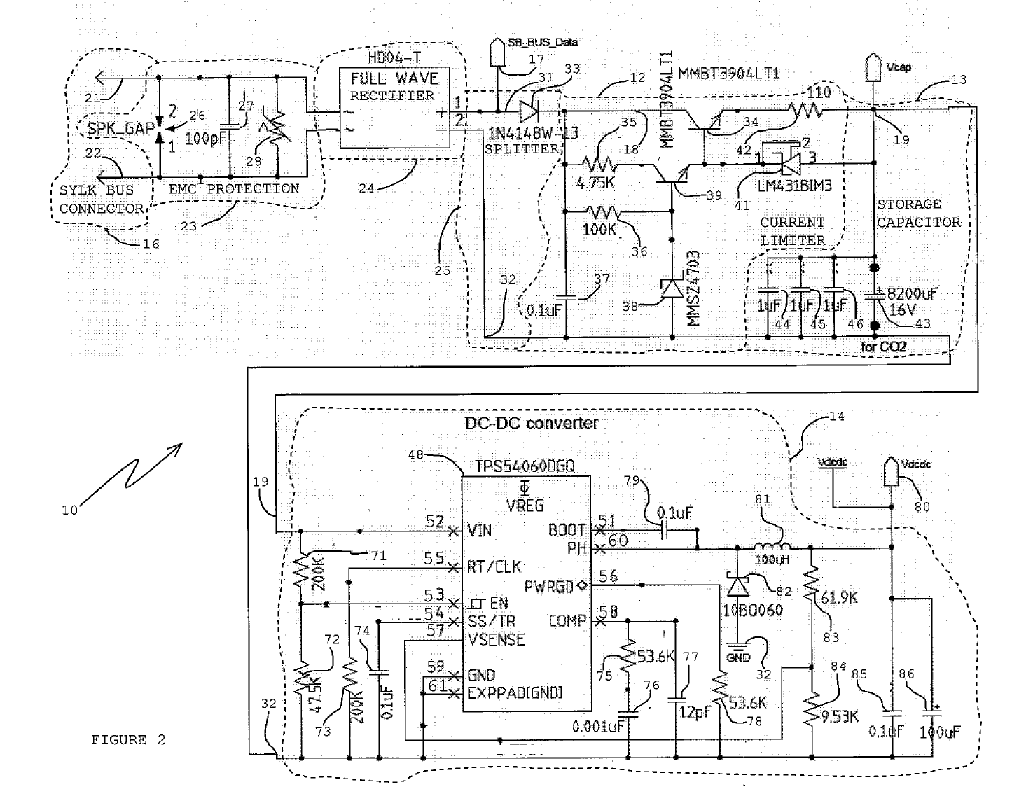

FIG. 2 is a diagram that shows more details of mechanism, module, approach or device 10 of FIG. 1. A sylk bus connector 16 may have two conductors 21 and 22 connected to an ECM protection circuit 23. Conductors 21 and 22 of the sylk bus may convey power and data signals to sylk module 11. EMC protection circuit 23 may have a spark gap 26 across conductors or lines 21 and 22. A 100 pico farad capacitor 27 and a varistor 28 may be connected across lines 21 and 22 in circuit 23.

Lines 21 and 22 may proceed through circuit 23. Circuit 23 may have a full-wave rectifier for providing polarity protection. An output line 31 may be connected to an anode of a diode 33 of splitter circuit 25. Data may be picked off at terminal 17 connected to the anode of diode 33. Power from a cathode of diode 33 may proceed along a line 18 to an input of current limiter 12. Line 32 from circuit 24 to splitter 25 may be regarded as a common reference terminal or ground for circuit 25, current limiter 12, storage capacitor 13, and DC-DC converter 14.

Line 18 may be connected to a collector of an NPN transistor 34, a first end of a 4.75K ohm resistor 35, a first end of a 100K ohm resistor 36, and a first terminal of a 0.1 microfarad capacitor 37. A second terminal of capacitor 37 may be connected to line 32. A second end of resistor 36 may be connected to a cathode of a zener diode 38 and a base of an NPN transistor 39. An anode of zener diode 38 may be connected to line 32. Zener diode 38 is not necessarily needed for a current limiter but may provide additional voltage protection to prevent a voltage higher than the 16 volts on storage capacitor 43 having, for instance, a rating of 8200 micro farads at 16 volts.

A second end of resistor 35 may be connected to a collector of transistor 39. An emitter of transistor 39 may be connected to a base of transistor 34 and to a cathode of a three terminal zener diode 41 having a low voltage rating and sharp characteristics. An emitter of transistor 34 may be connected to a first end of a 110 ohm resistor 42. A second end of resistor 42 may be connected to an anode of zener diode 41 and to an output line 19 of current limiter 12. A third terminal of zener diode 41 may be connected to the cathode of diode 41.

Lines 19 and 32 from current limiter 12 may go to a storage capacitor circuit 13. Line 19 may be connected to a positive terminal of an 8,200 microfarad polarity sensitive capacitor 43. A negative terminal of capacitor 43 may be connected to line 32. Three one micro farad capacitors 44, 45 and 46 may be connected in parallel with capacitor 43. Output lines 19 of storage capacitor circuit 13 may be connected to a DC to DC converter 14 voltage regulator integrated circuit (IC) 48. Circuit 48 may be a TPS54060 chip available from, for example, certain vendors of Texas Instruments products.

The discrete circuitry supporting IC 48 may be as shown in FIG. 2 or modified for a particular use. An example as shown for converter circuit 14 may have line 19 connected to a terminal 52 for a voltage in to IC 48. Line 32 may be connected to ground terminals 59 and 61 of IC 48.

A 200K ohm resistor 71 may have a first end connected to line 19 and a second end connected to an EN (enable) terminal 53 of IC 48. A 47.5K ohm resistor 72 may have a first end connected to terminal 53 and a second end connected to line 32. A 200K ohm resistor 73 may have a first end connected to a RT/CLK (timing resistor and external clock) terminal 55 and a second end connected to line 32. A 0.1 micro farad capacitor 74 may have a first terminal connected to an SS/TR (slow start and tracking) terminal 54 of IC 48 and a second terminal connected to line 32.

A 53.6K ohm resistor 75 may have a first end connected to a COMP (compensation) terminal 58 of IC 48. A second end of resistor 75 may be connected to a first terminal of a 0.001 micro farad capacitor 76. A second terminal of capacitor 76 may be connected to line 32. A 12 pico farad capacitor 74 may have a first terminal connected to terminal 58 of IC 48 and a second terminal connected to line 32. A 53.6 ohm resistor 78 may have a first end connected to a PWRGD (power good) terminal 56 of IC 48, and a second end connected to line 32.

A 0.1 micro farad capacitor 79 may have a first terminal connected to a BOOT (bootstrap voltage) terminal 51 and a second terminal connected to a PH terminal 60 of IC 48. A first terminal of a 100 micro henry inductor 81 may have a first terminal connected to terminal 60 and a second terminal connected to a V_{DCDC} output terminal 80. A zener diode 82 may have a cathode connected to terminal 60 and an anode connected to line 32.

A 61.9K ohm resistor 83 may have a first end connected to terminal 80 and a second end connected to a VSENSE (voltage sense) terminal 57 of IC 48. A first end of a 9.53K ohm resistor 84 may have a first end connected to terminal 57 and a second end connected to line 32.

A 0.1 micro farad capacitor 85 may have a first terminal connected to terminal 80 and a second terminal connected to line 32. A polarity sensitive 100 micro farad capacitor 86 may have a positive terminal connected to terminal 80 and a negative terminal connected to line 32.

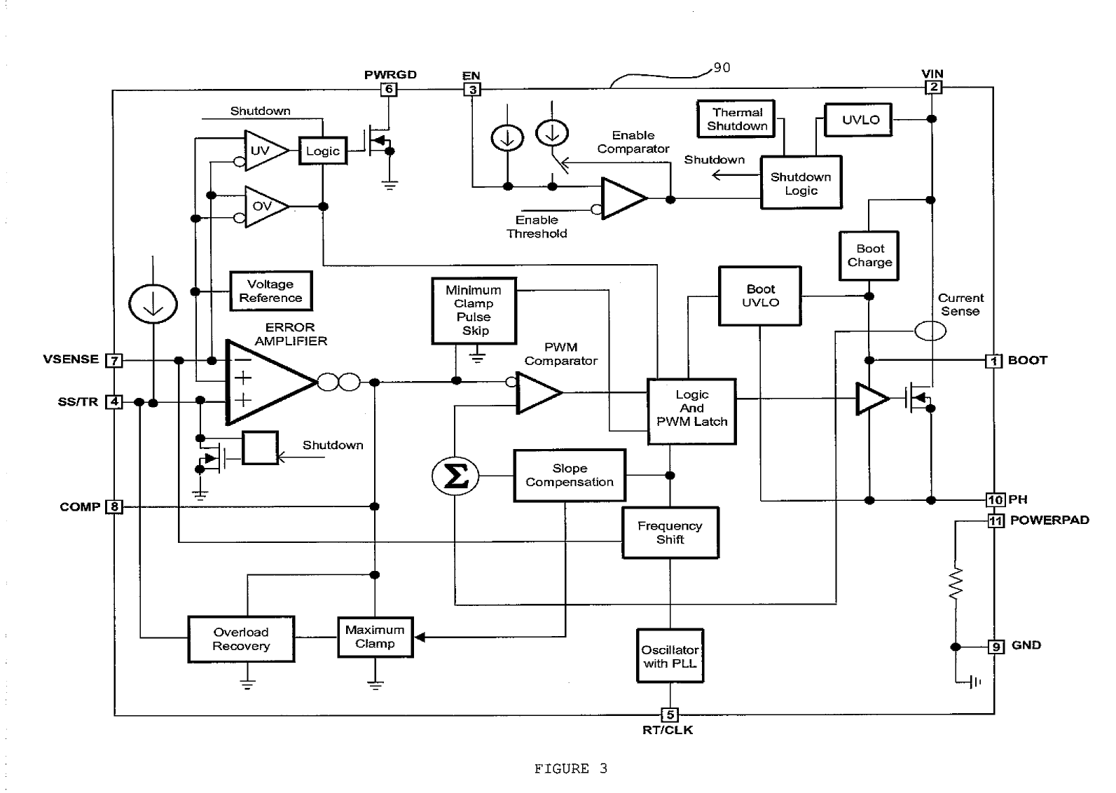

FIG. 3 is a Texas Instruments Inc. (TI) functional block diagram 90 of IC 48. Pin numbers (i.e., in the small square tabs) in diagram 90 plus a number 50 may correspond to pin numbers for IC 48 in FIG. 2, e.g., pin number 4 (SS/TR) of diagram 90 plus 50 equals pin number 54 (SS/TR) of IC 48.

Some of the less common parts in diagram 80 may be noted. Varistor 28 may clamp a voltage in both directions, such as an AC voltage, whereas a zener diode may clamp a voltage in just one direction. Varistor 28 may have a part number V56MLA1206NH and be available a from a Littlefuse parts vendor. Full wave rectifier 24 may be a diode bridge HD04-T available from Diodes Inc. or a Schottky diode bridge MB16S from Micro Commercial Components. Diode 33 may have a part number 1N4148W-13 and be available from a Diodes Incorporated parts vendor. Component 33 may have a reverse recovery time of four nanoseconds. Transistors 34 and 39 may have a part number MMBT3904LT1 and be available from a Motorola parts vendor. Zener diode 38 may have a part number MMSZ4703 and be available from a General Semiconductor parts vendor. Diode 41 may have a part number LM431BIM3 and be available from a National Semiconductor parts vendor. Diode 41 may be an adjustable precision zener shunt regulator. Diode 82 may have a part number 10BQ060 and be available from a Sensitron Semiconductor parts vendor. Component 82 may be a Schottky rectifier.

To recap, a power supply for a two-wire bus connected electrical module, may incorporate a protection circuit having an input for connection to a two-wire bus, a data and power splitter connected to the protection circuit, a current limiter connected to the data and power splitter, a energy storage cell connected to the current limiter, and a DC to DC converter connected to the energy storage cell. An output of the DC to DC converter may provide more intense energy per unit of time than the two-wire bus.

The protection circuit may incorporate an electromagnetic compatibility protection sub-circuit and a polarity protection sub-circuit.

The energy storage cell may incorporate a capacitor having a value greater than one microfarad.

The electromagnetic compatibility protection sub-circuit may incorporate a spark gap and a varistor.

The polarity protection sub-circuit may incorporate a rectifier.

The data and power splitter may incorporate a diode having an anode connected to an output of the polarity protection sub-circuit and a cathode connected to an input of the current limiter.

The current limiter may incorporate one or more transistors, and one or more zener diodes to limit a rate of flow of current to the energy storage cell.

The DC to DC converter may be selected from a group consisting of step-down regulators and buck converters.

An electrical input from the two-wire bus to the protection circuit may incorporate a first magnitude of energy for a first duration of time. An electrical output from the DC to DC converter may incorporate a second magnitude of energy for a second duration of time. The second magnitude of energy may be greater than the first magnitude of energy. The first duration of time may be greater than the second duration of time.

A mechanism for providing energy to a device, may incorporate a two-wire bus capable of providing power and data, an electromagnetic compatibility and polarity protection circuit connected to the two-wire bus, a splitter for extracting data from the two-wire bus, a storage capacitor, a current limiter for limiting an amount of current from the splitter to the storage capacitor, and a DC-DC converter for providing an electrical energy supply having greater intensity than the electrical energy supply available on the two-wire input.

The data on the two-wire bus may be from a CO2 module. The electrical energy supply from the DC-DC converter may be for sufficiently powering the CO2 module in a measurement mode. The energy supply on the two-wire bus may often be insufficient for the CO2 module in a measurement mode.

The data on the two-wire input may be for a secure digital card. The energy supply from the DC-DC converter may be for sufficiently powering the secure digital card in a writing mode. The energy supply on the two-wire bus may often be insufficient for the secure digital card in a writing mode.

The mechanism may further incorporate a controller connected to the storage capacitor. The controller may monitor a voltage at the storage capacitor and calculate when there is enough energy in the storage capacitor to provide an amount of intensive energy for operating a certain electrical device, or the controller may ensure an initial time period for storing energy in the storage capacitor to provide enough intensive energy for operating a certain electrical device without the controller monitoring the voltage at the storage capacitor. Energy from the two-wire bus may incorporate an insufficient amount of intensive energy for operating a certain electrical devices.

An approach for providing data and power relative to an electrical device, may incorporate providing a two-wire bus for conveying power and data, connecting a splitter to the two-wire bus for obtaining data from the two-wire bus, limiting current from the two-wire bus going to a storage cell, and monitoring an amount of energy in the storage cell to determine when there is a sufficient amount of energy to enable an energy intensive action by an electrical device.

The amount of energy in the storage cell may be monitored by a controller measuring a voltage at the storage cell and calculating when there is a sufficient amount of energy in the storage cell to enable an energy intensive action by the electrical device.

The approach may further incorporate providing electromagnetic compatibility protection between the two-wire bus and the splitter.

The approach may further incorporate protecting the splitter or the storage cell from incorrect electrical polarities on the two-wire bus.

The approach may further incorporate performing a DC to DC conversion of electrical energy from the storage cell to a greater amount of energy per a smaller duration of time that available from the storage cell.

The electrical device may be selected from a group consisting of sensors and memories.

The two-wire bus is a polarity insensitive bus.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A power supply for a two-wire bus connected electrical module, comprising:
a protection circuit having an input for connection to a two-wire bus;
a data and power splitter connected to the protection circuit;
a current limiter connected to the data and power splitter;
a energy storage cell connected to the current limiter; and
a DC to DC converter connected to the energy storage cell; and
wherein an output of the DC to DC converter can provide more intense energy per unit of time than the two-wire bus.

2. The supply of claim 1, wherein the protection circuit comprises:
an electromagnetic compatibility protection sub-circuit; and
a polarity protection sub-circuit.

3. The supply of claim 1, wherein the energy storage cell comprises a capacitor having a value greater than one microfarad.

4. The supply of claim 2, wherein the electromagnetic compatibility protection sub-circuit comprises a spark gap and a varistor.

5. The supply of claim 2, wherein the polarity protection sub-circuit comprises a rectifier.

6. The supply of claim 2, wherein the data and power splitter comprises a diode having an anode connected to an output of the polarity protection sub-circuit and a cathode connected to an input of the current limiter.

7. The supply of claim 1, wherein the current limiter comprises one or more transistors, and one or more zener diodes to limit a rate of flow of current to the energy storage cell.

8. The supply of claim 1, wherein the DC to DC converter is selected from a group consisting of step-down regulators and buck converters.

9. The supply of claim 1, wherein:
an electrical input from the two-wire bus to the protection circuit comprises a first magnitude of energy for a first duration of time;
an electrical output from the DC to DC converter comprises a second magnitude of energy for a second duration of time;
the second magnitude of energy is greater than the first magnitude of energy; and
the first duration of time is greater than the second duration of time.

10. A mechanism for providing energy to a device, comprising:
a two-wire bus capable of providing power and data;
an electromagnetic compatibility and polarity protection circuit connected to the two-wire bus;
a splitter for extracting data from the two-wire bus;
a storage capacitor;
a current limiter for limiting an amount of current from the splitter to the storage capacitor; and
a DC-DC converter for providing an electrical energy supply having greater intensity than the electrical energy supply available on the two-wire input.

11. The mechanism of claim 10, wherein:
the data on the two-wire bus is from a CO2 module;
the electrical energy supply from the DC-DC converter is for sufficiently powering the CO2 module in a measurement mode; and
the energy supply on the two-wire bus is often insufficient for the CO2 module in a measurement mode.

12. The mechanism of claim 10, wherein:
the data on the two-wire input is for a secure digital card; and
the energy supply from the DC-DC converter is for sufficiently powering the secure digital card in a writing mode.

13. The mechanism of claim 10, further comprising:
a controller connected to the storage capacitor; and
wherein:
the controller monitors a voltage at the storage capacitor and calculates when there is enough energy in the storage capacitor to provide an amount of intensive energy for operating a certain electrical device, or the controller ensures an initial time period for storing energy in the storage capacitor to provide enough intensive energy for operating a certain electrical device without the controller monitoring the voltage at the storage capacitor; and
energy from the two-wire bus comprises an insufficient amount of intensive energy for operating a certain electrical devices.

14. A method for providing data and power relative to an electrical device, comprising:
providing a two-wire bus for conveying power and data;
connecting a splitter to the two-wire bus for obtaining data from the two-wire bus;
limiting current from the two-wire bus going to a storage cell; and
monitoring an amount of energy in the storage cell to determine when there is a sufficient amount of energy to enable an energy intensive action by an electrical device.

15. The method of claim 14, wherein the amount of energy in the storage cell is monitored by a controller measuring a voltage at the storage cell and calculating when there is a sufficient amount of energy in the storage cell to enable an energy intensive action by the electrical device.

16. The method of claim 14, further comprising providing electromagnetic compatibility protection between the two-wire bus and the splitter.

17. The method of claim 14, further comprising protecting the splitter or the storage cell from incorrect electrical polarities on the two-wire bus.

18. The method of claim 14, further comprising performing a DC to DC conversion of electrical energy from the storage cell to a greater amount of energy per a smaller duration of time that available from the storage cell.

19. The method of claim 14, wherein the electrical device may be selected from a group consisting of sensors and memories.

20. The method of claim 14, wherein the two-wire bus is a polarity insensitive bus.
